(19) United States
(12) Patent Application Publication
(10) Pub. No.: US 2025/0037137 A1
(43) Pub. Date: Jan. 30, 2025

(54) METHODS AND SYSTEMS FOR A CLOUD-BASED, INTELLIGENT AND INTERACTIVE VIRTUAL CONTAINER BASED CUSTOMER SERVICE PLATFORM

(71) Applicant: Zingly Inc., San Ramon, CA (US)

(72) Inventors: Jafar Adibi, Los Angeles, CA (US); Gaurav Passi, San Ramon, CA (US); John D'Amour, Capitola, CA (US); Brian Schnack, Capitola, CA (US); Piotrek Chojnowski, Nashville, TN (US)

(21) Appl. No.: 18/715,799

(22) PCT Filed: Dec. 5, 2022
(86) PCT No.: PCT/US2022/080913

§ 371 Date: Jun. 3, 2024

Related U.S. Application Data
(60) Provisional application No. 63/285,617, filed on Dec. 3, 2021.

(51) Int. Cl. G06Q 30/01; G06F 40/30; H04M 3/523

(52) U.S. Cl. CPC G06Q 30/01; G06F 40/30; H04M 3/523

(57) ABSTRACT

Systems and methods provide a cloud-based intelligent and interactive customer service platform that includes a communication manager, customer app, agent app, a virtual container (e.g. room) for communication, a natural language processor, voice processor, image processor, video processor, and an inference processor exposed by application programming interfaces; and executing an agent picker functionality within the automation infrastructure that performs operations comprising: receiving a communication from a customer; immediately analyzing the communication to determine the right agent; automatically understanding the state of the room parsing a knowledgebase for some of the conversation to the subject associated with the customer's communication; providing the state of the room to agent within a unified interface during the communication with the customer, capability to rate other party and add and drop multimedia to all containers.

### PRIORITY CLAIM

The present application claims priority to U.S. provisional patent application Ser. No. 63/285,617, filed Dec. 3, 2021.

### BACKGROUND

Conventional contact centers have a several disadvantages when dealing with customers who want to be flexible and would like to seat in the center of the conversation. Customer service consists of a medium that allows customers to contact the brand and talk to agents (e.g., customer service representative, or company employees) whether they are on-premises or on the cloud software solutions. This might happen via phone calls, video calls, chats, social media connections, text messages, emails, or other channel mediums. While many conventional contact centers provide a toll-free (e.g., 800) number, email, or a chat service still customer does not have an easy way to access old information get back to the old issue that the customer was dealing with, and several other challenges. Furthermore, conventional contact centers are not inflexible and do not allow customers to choose their favorite agent and refer to previous conversation from their point of view.

Contact centers might provide all these channels to their customers and terms such as multi-channel or omni-channel are used to represent such capability. However, all these mediums have their own disadvantages and might not address what a modern customer is looking for. New generations are always on their smartphones and smartphones are not only part of their identity, but they are also part of their lifestyle.

The new generation expects to do everything with their phone, and they expect any service provided via phone to be easy to use, smart, consistent, interactive, and real-time. Well known services such as Google's search engine, Facebook's Instagram, Apple's Siri, and Amazon's Alexa have raised the expectations of the new generation. The new and modern users is looking for a new medium as a central point to contact with all brands, have access to data persistently, can talk to the agent and any time they want, can pick the agent or type of the agent they are looking for, understand where in the journey they are, have visibility into agent ranking and agent performance score and several other features that current contact centers lack such features. To meet such demands a new medium as the main channel for customer engagement and service is required.

### BRIEF SUMMARY OF INVENTION

In one general aspect, the present invention is directed to systems and methods for providing a cloud-based intelligent and interactive customer service platform that includes a communication manager, customer app, agent app, a virtual container (e.g. room) for communication, a natural language processor, voice processor, image processor, video processor, and an inference processor exposed by application programming interfaces; and executing an agent picker functionality within the automation infrastructure that performs operations comprising: receiving a communication from a customer; immediately analyzing the communication to determine the right agent; automatically understanding the state of the room parsing a knowledgebase for some of the conversation to the subject associated with the customer's communication; providing the state of the room to agent within a unified interface during the communication with the customer, capability to rate other party and add and drop multimedia to all containers.

In accordance, a cloud-based software platform is disclosed in which the example method above is performed. Agent and customer app could be one role-based app that the user might use with different features depending on the nature of the user.

Additional features and advantages of the present application will be set forth in the description which follows, and in part will be obvious from the description, or may be learned by the practice of such example embodiments.

### FIGURES

Various embodiments of the present invention are described herein in connection with the following figures.

FIG. 1 shows how Customers and Agents (or employees) connect to each other via an app in the cloud. The Customer and Agent app could be one App or could be different apps depending on the situation. The Customer connects to the cloud (could be any cloud platform e.g., Amazon, Google or others). Agent also connects the cloud and these two communicate to each other via the cloud. The Customer APP could be, for example, a mobile app or a web-based app that runs on any device with a browser. Agent app is also the same; it could be, for example, a mobile app or a web-based app running on any browser. Browser could be on any laptop, desktop, mobile device, tablet, etc.

FIG. 2 illustrates the relationship between a Communications Platform as a Service (CPaaS) provider (platform provider for communication including text, audio, and video), customer and agent app and service provided by the platform. These services comprise, for example, customer relationship management (CRM), Workforce Engagement Management (WEM) to measure the efficiency of the employees, agents and customers, Apps (such as payment, calendar, and other apps), search capability to search within and across all rooms, and AI services including but not limited to discovering sentiment, temperature of the room and customer intent. Customer app can connect to the cloud via two main components: (i) via in-app chat, a module that makes text communication possible; and (ii) via the CPaaS platform, which is Communication Platform as a Service. CPaaS makes voice, audio, video and notification possible. Agent app connects to the cloud and to chat and CPaaS platform the same. Agent app is able to call one of the above-mentioned services. The CRM component could be any customer relationship managing and any room/container creation by parties or systems will reflect in the customer relationship management software or similar softwares and any change in room state might reflect to the customer relationship management, front-office, or back-office software associated with the room.

FIG. 3 illustrates the concept of a room as a virtual container. A room has status (which shows the state of the customer's customer service issue (e.g., resolved)), and this state is determined by the system and is illustrated on the top of the container. A user can select the channel (where customer and agent can talk, chat or video chat) and past interactions (e.g., text and voice etc.). User can select the desired channel to contact the other party. Container shows the past content. Such content could be all text communicated between agent and customer in past or any other event that happened in the past. These events can include, but are not limited, to when the agent leaves the room, when the customer leaves the room, when the agents enter the room, when the agent switches with another agent, etc. There is also a specific component as “communication container” where the actual live communication happens.

FIG. 4 illustrates the lobby (where user can see all rooms) and search capability within one room and all rooms. Lobby is the super container in which the application shows all containers (aka rooms). Each room is identified by the title or topic of the room, which shows the summary of the discussion. User can use the search option to search for a room. This could be searching for a specific word, name, place, time, topic, etc. The result of the search can be illustrated in the main container.

FIG. 5 illustrates assigning the right agent to the right customer. When a customer comes to a room, a routing engine of the system looks at the customer attributes and looks at agents and employees who are available and can talk or chat with the customer, and picks one agent/employee and assigns the selected agent/employee to the customer. In this flow, the customer might ask for specific agent or define the criteria for the agent selection. For instance, the customer might say “I like to talk to the same agent I talked last time” or “I do not want to talk to the same agent I talked last time.” The routing engine goes to the pool of available agents and brings a list of agents that fit within the criteria. The routing engine assigns the right agent to the room. If there is more than one agent, routing engine might pick the right agent randomly, via a round-robin format, or via another algorithm defined in the agent assignment module. After the assignment, the select agent will join the room and start communicating with the customer. The customer is already in the room and has the capability to continue the discussion or leave the room or ask for another agent. The agent can change the states or status of the room as well.

FIG. 6 illustrates system capability to discover room temperature (hot when customer is not happy and cold when customer is happy) and customer sentiment by looking at, among other things, information in the room, such as text, audio, and video. In this flow, a sentiment engine analyzes the content of the room. This content could be text, voice, audio images and all other meta data related to such communication to determine the sentiment of the customer. After getting the sentiment, a temperature engine can use the metadata to discover the room temperature. Room temperature could be “hot” meaning the customer is not happy, or “cold” meaning the customer is happy, etc. The background color of the room could change accordingly as an indicator to show the customer is happy, sad, confused, etc.

FIG. 7 illustrates a transparent environment for agents (or employees) and customers to rate each other's performance. The system provides an opportunity for the agent and customer to rate each other. Agent rates customer and customer rates agents and such ratings go to a score calculator. The score calculator considers several data such the number of communication and actions agents or customer had in past, the sentiment of the communication, etc. to calculate the score and such score goes to the profile of the agent or customer. Those ratings could be shown to customers and/or agents in the application or could be hidden.

FIG. 8 illustrates how the system finds similar room conversations and content based on information such as text in the room and customer information. In this flow the feature extractor modules either extracts all features or use all raw data. This module does the same for all rooms in the system. Next, the module searches for all similar rooms that share the same features and have similar features. Next it shows which room or set of rooms are like this particular room, which means they are talking about the same topic or addressing the same issue, etc. This result goes back the room and the agent can see which other rooms are like this room so that the agent has the capability to go and visit similar rooms.

FIG. 9 illustrates how a room template can initiate after the topic is picked by the customer. If, for example, customer select sales, then a room template associated with be picked by the system and a room will be created within such template.

FIG. 10 illustrates the flow of discovering room status according to various embodiments. Status analysis modules used room content, past content, current content, topic etc. to figure out the right status of the room, and based on that it sends the result to a status broadcaster (to broadcast to all components) and a status assigner, which can change the status of the room.

FIG. 11 illustrates the flow of template selection for a room according to various embodiments. After a user or the system assigns a topic to the room, the system goes to a room template database and a template picker picks the right template associated with the right topic and assigns the selected template to the room.

FIG. 12 illustrates the flow, according to various embodiments, of a customer asking for an agent, then the bidder module getting the price for talking to an agent via a bidding system. Based on the bidding, if the request is successful, the customer will be charged and then an agent that the customer successfully bid for will be assigned to the customer.

FIG. 13 illustrates the search flow within a room according to various embodiments. Users search for a word or any other content (e.g., URL, image etc.) and the word goes to a search engine and the result will be select by result finer. The result of the search will be illustrated in the room.

FIG. 14 illustrates how the customer can see various brands in the customer's lobby according to various embodiments.

FIG. 15 illustrates the ad flow according to various embodiments. Data analysis modules capture information within the room and analyze the content, and send the result to an ad database, which send the results to ad bidding system to pick the right ad with the higher bid, and then the right ad will be assigned to the room, lobby, or any other potential available containers.

FIG. 16 illustrates examples of room templates. Each room might can have a set of statuses associated with such template.

FIG. 17 illustrates an example of a flow in a room according to various embodiments. Each arrow indicated possible transaction from one status to another status. Each room template is associated with a flow.

FIG. 18 illustrates communication and connection between agent and customer in a virtual reality room according to various embodiments. In addition, the customer and agent can meet in a virtual reality environment, or they can meet in a virtual reality game, space, etc.

FIG. 19 is a diagram of an overall system, including a customer device, an agent device, and a customer service system, according to various embodiments of the present invention.

FIG. 20 is a diagram of a computer system for training machine learning models of the customer service system of FIG. 19 according to various embodiments of the present invention.

FIG. 21 is . . . .

### DETAILED DESCRIPTION

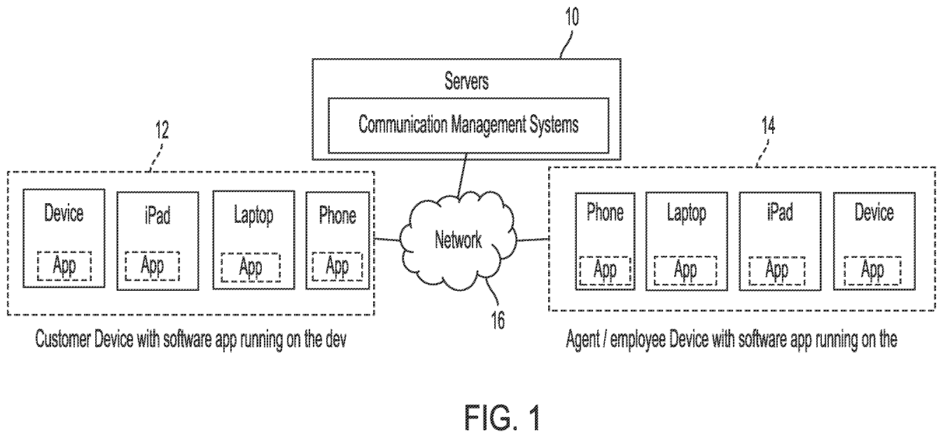

As illustrated in FIG. 1, a system according to various embodiments includes one or a number of inter-networked servers 10, comprising a customer service system, which might generate, store, process, receive and transmit data between a customer device 12 and an agent device 14. A customer associated with a customer device may have a customer service issue. The customer service system selects an agent, associated with an agent device, to address, and hopefully resolve, the customer's customer service issue. The data can be in the form of digital and electronic data and could be text, voice, image, movie, or any other type of electronic signal which might transfer dialog data, external data, contextual data, user information and other types of data. Any suitable devices for communicating with the servers 10 via an electronic data network 16 can be used for the customer and agent devices 12, 14, such a mobile devices (e.g., smartphones, tablets, etc.), laptops, etc. The customer and agents devices 12, 14 may include a software application as described herein for communicating with the servers 10.

Servers 10 also might transfer data to the agent and customer devices 12 using the network 16. In some setups, the servers 10 are a collection of application servers, communication servers, a web-hosting server, a social networking server, and a digital content management server. In other embodiments, a different server setup might be used. For instance, the agents and customers might connect directly or on a network residing on a local device. The customer service system 10 also might include several databases to store user information, contextual information, forecasting information, network information etc.

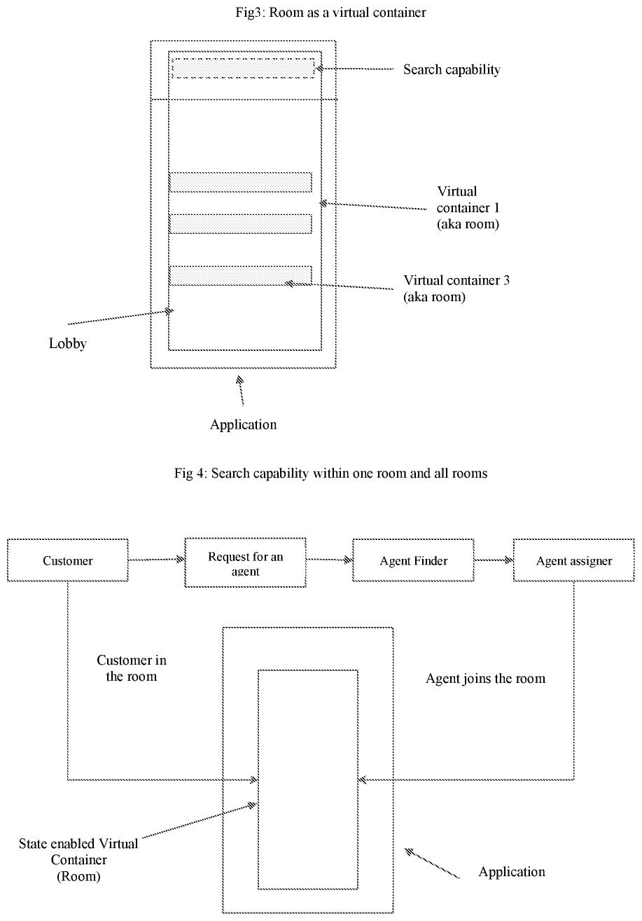

As illustrated in FIG. 3, methods and systems of the present invention can provide for a new state-enabled cloud-based medium for the customers to interact with an agent or group of agents in a drop-in virtual container. The agents are representatives of a contact center, a company, an organization, a 3rd party organization, members of a family or other type of entities. The container could be one or a combination of the following: (a) Text based container in which customers and agents can drop-in and engage with each other synchronously (live) and asynchronously (non-Real-time); (b) Voice based container in which customers and agents can drop-in and engage synchronously and asynchronously; (c) Video based container in which customers and agents can drop-in and engage synchronously and asynchronously; (d) Social media-based container, e.g., a post, video blog, etc., where customers and agents can drop-in and engage synchronously and asynchronously; (e) The container contains engagement across all media types (text, voice, video, social, more); (f) Integrated container in which customers, agents, and systems can engage, e.g., a party can initiate a payment request through the room, triggering an integrated process with an integrated system, with the status and results published to the room; and/or (g) Customer and agents could be human, a robot or a chat bot.

As illustrated in FIG. 3 and explained herein, the methods and system of the present invention can provide for a virtual container, aka “room,” where customers and agents can chat, message, talk, video call, and otherwise drop-in and engage synchronously and asynchronously to discuss issues (e.g., a customer service issue of the customer), research, resolve, and otherwise engage to understand and meet the customer's objective. According to various embodiments, room data is persistent and is available for all parties (“Party” refers to a customer, agent, and other employee of the enterprise (“brand”) employing the agent, or 3rd party user assisting the brand). Unless otherwise stated, all visibility, access, and activities available to parties is subject to roles- and rights-based privileges (hereafter referred to as “subject to privileges” or “privileges”). Also, room data can be searchable by all parties (customers, agents, etc.). Multi-media files can be uploaded in the room for use by all parties. All events occurring through the room by parties, the system running the room itself, and integrated systems (e.g., integrated CRM, payment system, shipping system) can be published to the room so that it is visible to all parties, with appropriate details and metadata. Each party may know about the presence of the other party (e.g., agent sees customer is in the room; customer sees agent is viewing document in the room; customer sees agent is on a call but not viewing the room). Also, in other embodiments, each party may hide the presence of themselves from the other party. There can be a separate container for all multimedia and in each category (e.g., audio, video, image, text, link etc.). Each party may talk, chat, text, video call, or otherwise communicate via an available technology medium with the other party in synchronous and asynchronous manner. Each party may conference with other parties; each party may video conference with other parties; and each party may have the capability to add and drop other parties. The virtual container (e.g., room) can be opened to public or the room can be hidden from public. A room could be shared in a social media via a link so other parties can join. Also, a room could be shared in search engines.

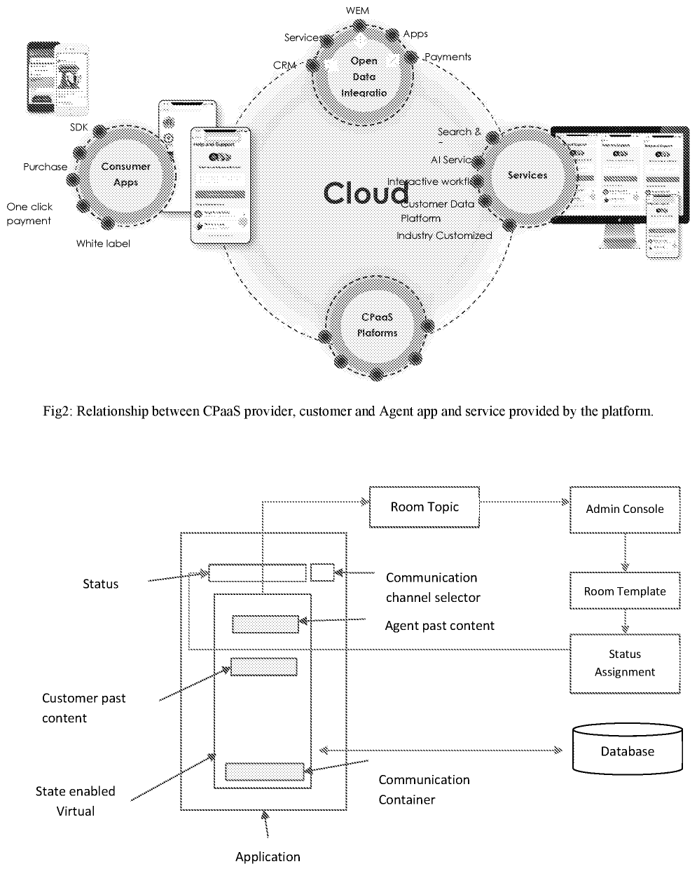

As illustrated in FIG. 2, customers and agents (e.g., employees) for or of a company can communicate via an app. This communication might happen between two or more than two people who would like to connect and communicate, particularly to address a customer service issue of the customer with respect to a brand product or service. This could be for the purpose of sales, support, a simple communication purpose or for any other reason. The communication can be enabled by Communications Platform as a Service or CPaaS. CPaaS is a cloud-based delivery model that provides communication like voice, video, and SMS. It acts as a platform for businesses to connect with their own customer applications using Application Programming Interfaces (APIs). For example, a company/brand could use a chat app API to integrate messaging platforms for their customers.

The customer app, on and executed by a customer device 12, might be in form of a mobile application (app), or it can be embedded within an existing app via a Software Development Kit (SDK). The customer app can provide an option for a customer to purchase a product or service from the relevant brand via the app via one click payment option. One-click payment option is an integrated third-party application which enables customers to buy any item via the app and the money will be transferred to the company/brand via the network. The customer also has the option to have several brands on the app, hence the customer can click on each brand in the customer's lobby and the application goes to the selected room/container for the brand for communication. In addition, the client can white label the application.

As illustrated in FIG. 2, the app might be a stand-alone app on the customer device or integrated in other applications (e.g., desktop app, mobile app, web app etc.).

As illustrated in FIG. 2 data can be stored in databases in the cloud. This includes structured data (e.g., numbers, names, values) and unstructured data such as text, voice, movies, and images. The storage can be in the form of traditional data storage or in form of blockchain for the purpose of security.

The databases can provide an API to connect to other third-party applications. Examples of these third-party applications include but are not limited to Workforce Engagement Management (WEM) applications for contact center load forecasting (e.g., how many interactions a contact center might have in a given day), scheduling applications (e.g., which agent has to show up in what data and time), and employee engagement (e.g. gamification of the application to increase the agents' productivity).

As illustrated in FIG. 2, the platform might integrated to other Customer Relationship Management (CRM) software as well. This is to make sure the communication within the application and within a room is synced with the CRM data.

As illustrated in FIG. 2, the open platform makes the application capable to be integrated with other applications (named as “app” in the figure), including but not limited to communication applications, contact center applications, calendar applications, financial applications, sales applications, marketing applications, payment applications, workforce management application, workforce optimization applications, etc.

As illustrated in FIG. 2, the agent/employee application can be enriched with capabilities such as the following: Search (to search for a given word, image, sounds voice movie in one room or across all rooms or all brands); an AI chatbot to communicate with customer via a robot up to a point that such conversation cannot move forward; an AI sentiment analysis to detect the mood of customer and to signal to the agent and other management when customer is not happy; an AI intent spotting service to understand and discover customer intent to route the customer to the right agent and to bring the right information to the room; and/or an AI service to measure how long it takes one agent can join the room now or later in the day to smooth the interaction with customers.

As illustrated in FIG. 2, the agent app data can be enriched with more data. A customer data platform (CDP) is a technology platform used for collecting and managing customer data for marketing, sales, and other purposes. A CDP acts as a unifying platform to collect, organize, analyze, and activate all type data. This could be first-, second-, or third-party data from any source, including but not limited to online, offline, mobile, purchase data, social media data, interaction data and beyond. A CDP can be used to discover and activate audience segments, which are used to target user segments for engagement, advertisement, marketing, and sales.

However, current CDPs are scattered as customers use different channels to contact different brands. In this case, the CDP can integrate data by integrating data from multiple data sources. Such integration could be done anonymously as well. In addition, the CDP can unify customers by consolidating and unifying customers across all brands and contextual analysis and provides analytics by providing audience insights.

The CDP can also provide activation by creating audiences and activates against specific segments for a room, several rooms, and several brands. In addition, the CDP can provide information on customer behavior and understanding, and provide insights and segmentation. By integrating such data sets, richer customer profiles might be created, considering privacy and compliance.

When customer and agents are in a room interacting with each other there are several external services that can be provided to both agents and customers. These services can be referred to as “room-service.” The methods and systems of the present invention can provide for an integrated virtual container in which customers, agents, and systems can engage by requesting, initiating, completing, and viewing real-time and historical state of activities executed by integrated software systems outside of the virtual container itself (“room service”), e.g., a party can initiate a payment request through the room, triggering an integrated process with an integrated system, with the status and results published to the room (as illustrated in FIG. 3).

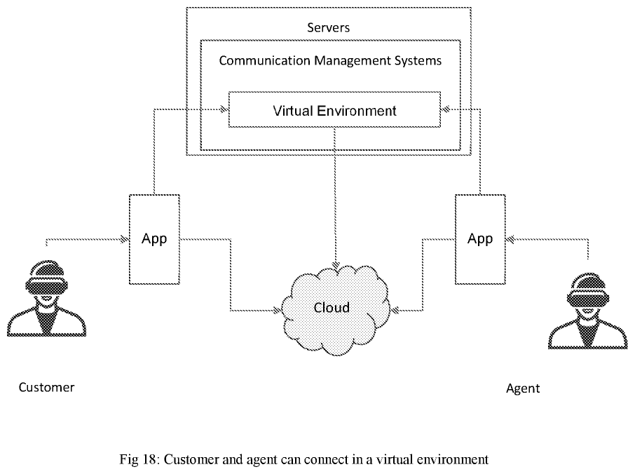

The virtual container (room) can be integrated with other software systems for the benefit of helping engage parties and progress the room toward its objectives. Each party, subject to privileges in the room as well as the integrated software system (“integrated system”), can readily request initiation of an action (“room service”) to be executed by the integrated system from within the room, e.g., customer types a non-complex command in the room which initiates. Room service can be initiated or updated by both non-complex commands (e.g., start payment) and non-typed commands (e.g., right-mouse click, highlight and long press). Room service can pass context to the integrated system from the room, e.g., pass requesting a party's credentials, room number for consumption by payment system, etc. Room service can receive context from the integrated system for the purposes of display and further action in the room by parties. e.g., payment system returns a unique payment ID, along with a next step to the requesting party to confirm or reject. Parties can add context to the room service after initial execution of the room service, e.g., after initiating a multi-step payment process, the initiating party wishes to increase the amount paid. Room service can be paused—and hence resumed—after initiation, e.g., the initiating party realizes they need to check their bank balance before completing the payment they just initiated. A party (e.g., customer) can request, in natural language or via controls, pausing the service. Room service can be cancelled, e.g., the initiating party realizes they have insufficient funds, and they cancel the payment request. Room service status shall be visible to parties, e.g., the initiating party and the primary room owner separately can see the payment status for the payment initiated. Room service can be simple or complex; specifically, they can be single or multi-step, serial or parallel, e.g., the room service can negotiate a multi-step process as part of a payment. For example, when payment is initiated, the payment system returns context, the initiator is asked to select payment amount, payment method, and payment date; the initiator is then asked to answer a security question to finalize and confirm payment. Room service can render the integrated system within the room itself, e.g., for completing a payment, the initiating party can navigate payment completion within the room without leaving the room. Room service can be completed, e.g., the payment is successfully completed, with the transaction status and details provided to the room. Room service can have appropriate error handling, e.g., after initiating a payment, the payment system fails to process the payment. An adequate error message and log can be returned to the room for party visibility and follow up, if not troubleshooting by back-office personnel. Parties can search and view a comprehensive history view of all room services executed for the room, including date/time stamped events in summary and detail view of initiation, pause, resumption, update, cancellation, and completion of the room service. Every step in the room service between initiation and completion can be securely managed and authenticated. The room service can have authenticated access to the integrated system (e.g., tokenized access). Likewise, the integrated system can have authenticated access to the specific room, if not the system running the virtual container itself. Room service can be configurable by a human such as business analysts or an automated system. Room services can be extended by selecting from a library of service connectors including 3rd party systems (e.g., payment system, signing system, etc.). Parties can connect to a room via a virtual reality glass and meet each other in a virtual environment. (FIG. 18). Also, parties can connect to a room in a virtual reality environment (e.g., game) as well. This means parties can meet in a virtual reality game, or in a virtual reality room where both parties can use a glass to meet in the virtual environment such a game environment or non-game yet virtual reality environment (FIG. 18).

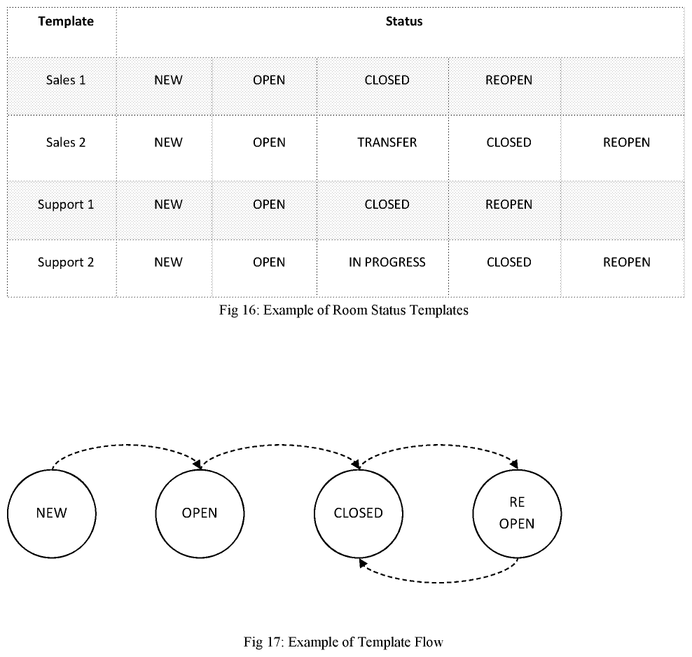

Current customer service and sales platform are stateless. It means in most of the cases there is no visibility for the customer and agents to know where they stand in the process. The entire customer journey would be smoother if customers know their problem is close to the end or there is a long way to resolve the issue. To address this issue, in various embodiments, “rooms” stats (or conditions or status) are enabled and to do this the methods and systems of the present invention can provide for state- and condition-enabled rooms (“state” or “status”). As illustrated in FIG. 3, a given state indicates in which state is the progress of completion of the room with the customer; for instance, the room's state could be “start negotiation” in a condition of “new”, “unfinished” with a condition of “in-progress”, or “resolved” in a condition of “closed” (which could be derived from other states). Each room can be associated with a template (FIG. 16) and each template can be associated with a flow (FIG. 17). The flow indicates the potential transition from one state to another.

Custom room status designations can be created through the system administration console. These designations can be mapped to one of, for example, four system defined conditions and can be extended by customers: (i) NEW, which denotes a status where the room is initially created, and first action (customer designation) has not occurred; (ii) OPEN, which denotes a status where general work is being done on the issue of the room (example: agent is troubleshooting) and a resolution has not yet been identified; CLOSED, which denotes a status where the room is no longer active (new activity cannot happen, in various embodiments, in the room other than to “Reopen” the room) and (iv) REOPEN, which denotes a status where the room was previously closed but has for any reason been reopened.

Each room might associate with a set of statuses in connection or in series to each other. For instance, a room might go from OPEN to INVESTIGATION to CLOSE. Each room might have its own flow (FIG. 16). To address this, methods and systems of the present invention may define a service specific/issue specific workflow within a room. A designated room category will determine a room template that will be applied to the remainder of the room's lifecycle and will determine the following: (a) Room Category, a custom designation created through an admin console. This category designation can be used to determine the template flow that will be applied to the room; (b) Status Flow; through a flow diagramming interface, a business analyst can define how individual status connects with the other status creating a flow and defining the constraints of which status can move to another; (c) Status Conditions; each customer status can have defined conditions that must be met in order to be able to move to that status. These conditions can be enforced through automated means (bot) or through manual (scripting to agent). Conditions can be designated with different status and would act as a branching mechanism to decide which of more than one status to move to next. Conditions can contain scripting languages that can be presented to a user in the context of a room to collect the required conditional information. Conditions can contain enriched information which may be a defined selection list or come from results of an API call to an external system; and (d) Auto Status Change, a status may be designated as “auto” meaning that if the defined conditions are met then move to the next defined status.

Rooms might have different look and feel. A room to discuss a sport issue might be totally different with a room which is assigned to address phone issues. A room's background of one brand also might be different in appearance with other brands. Methods and systems of the present invention can provide for the virtual container's (room's) look, feel, style, details, content, and available functionality to behave uniquely and conditionally based on criteria specific to the party using the virtual container as well as criteria of the room itself. The room can look and feel, and be white labeled, uniquely based on criteria specific, such as: Parties, such as the party who created the room, is the primary room owner, e.g., an agent may provide service for multiple brands, but a particular room's look, feel, and behavior shall conditionally adjust to fit the profile for the specific brand which the agent is currently representing; and/or is a member of the room; Content and context of the room, for example, a customer may receive services from different groups of a same brand (e.g., banking, investment services, credit card), but their room to handle a (e.g.) banking issue shall uniquely look and feel as a “banking issue” room; and/or Similarly, functionality available to parties in the room shall also be conditional based on above criteria.

As the numbers of rooms grows for a brand or for a customer, search becomes important. To make a customer journey easier, the methods and systems of the present invention can provide for customers to search and find rooms as illustrated in FIG. 4. In various embodiments, parties can search and find the room that a party has opened about a specific issue in the past. Parties could search for and find the room that other parties (or systems) have opened about a specific issue in the past (if these rooms are open to public). The room can be found in the following ways: (i) Ranked list based on time, name, number of participants etc.; (ii) Via an abstract description, e.g., “which room was about our router”; (iii) With some multimedia references, e.g., “the one I uploaded my fridge image”; (iv) With some reference to the agent features, e.g., “the one I talked to with southern accent”; (v) With some references to the agent's name, e.g., “her name was Mary or something like that”; (vi) With some references to the emotional state of the customer or agent, e.g., “the one that I got mad, or I was frustrated”; (vii) With some references to the state of the room, e.g., “the one which is closed or not resolved” or “all rooms which are not open”.

The entire platform can be integrated with other softwares and Customer Relationship Management (CRM) platforms. Such integration syncs “rooms” with the CRM. For instance, if an issue is resolved in CRM via other ways beside the rooms, such resolution can be reflected in the room as well and it shows that the issue has been resolved. To address such synchronization, the methods and systems of the present invention can integrate and couple a room, and any changes in the state/condition of the room with other potential softwares and systems (e.g., CRMs). As illustrated in FIG. 2, any room creation by parties or systems can be reflected in the customer relationship management data or similar application data; and/or any change in room state might reflect to the customer relationship management, front-office, or back-office software associated with the room.

Rooms are preferably state enabled. An AI based system, CRM, software, agents, or supervisors can change these states as the interaction progresses over time. The methods and systems of the present invention can change a room's state by any user, customer, agent, or system (e.g., computer program) as illustrated in FIG. 3. State can be changed by the agent or by the customer in the room; state can be changed by people outside of the room (e.g., supervisor); and/or state can be changed by another software system (e.g., associated CRM).

While agents and supervisors can change the state of a room, the states can also be changed automatically. For instance, from the conversation between the agent and the customer, an AI-based system can analyze words and understand that the issue has been resolved. As illustrated in FIG. 10, the methods and systems of the present invention can include an intelligent software system to change the state of the room via artificial intelligence, machine learning and other statistical models. State might change depending on the flow of the conversation, e.g., if customer says, “thanks very much that's all I wanted”, the state will turn to “closed”. The state of the room can change based on other rooms. For example, if current customers think the issue is resolved and many other customers with the same issue think the issue has not been resolved, the state will change to “unresolved” to represent the correct situation. A feature-based system can change the state of the room based such features and attributes. The system can learn rules from the set of important features and apply such rules to subsequent instances. These features could be extracted from voice, video, words, time of the day, day of the week and potentially any other features of conversation, e.g., by looking at millions of conversations' transcripts. For example, from communications such as “iPhone black screen” and “send it back to the manufacturer,” the system understands that the iPhone is a device, screen is associated with the device, iPhone is a brand, black is color, etc., and by analyzing millions of records it understands there is a correlation between these two sentences. A featureless system to change the state of the room based on raw data with no explicit features including voice, video, and text signals. The system can use deep learning and not extract any feature, rather by learning from all raw data from a large set of datasets, e.g., by looking at millions of conversations' transcripts, the system understands that the “iPhone black screen” is correlated strongly with “send it back to the manufacturer” without extracting any word, entity, object, verb etc.

The state of the room is the representative of the customer journey. For instance, it shows if the customer service issue is resolved, if the customer has reopened an old issue, if the room is open for a long time, etc. Such state preferably is known by all parties, components and integrated systems. As illustrated in FIG. 10, the methods and systems of the present invention can broadcast the state of the room to other rooms, people, devices, desktops, software systems and entities. The state of the room can be broadcast to the customer as well as managers. The state of the room can be broadcast to other relevant parties (e.g., supervisor, parents, etc.). For instance, if the agent is abusing a customer verbally or using foul language, the state of “customer is angry” can be broadcasted to supervisors. The state of the room or any change might be sent via notification to the user phone, desktop, tablet, etc.

The state can be detected automatically to makes the whole experience smooth for both agent and the customer. The methods and systems of the present invention can detect the state of the room (e.g., room is closed or resolved) automatically as shown in FIG. 10. The state can be detected based on designated conditions as defined in the room template workflow. Additionally or alternatively, the state can be detected based on the textual conversation between agent and customer. Additionally or alternatively, the state can be detected based on the voice signal between customer and agent, such as the tone of speech, coughing, laughing, crying, the speed of the conversation, the number of interruptions and/or the volume of the voice. Additionally or alternatively, the state can be detected based on video between agent and customer. This can include extracting information from video processing if the customer is (for example), angry, happy, normal, frustrated or not, frowning and/or other potential face states, such as neutral in what would otherwise be expected to be a highly positive or negative moment. The state can also be detected from uploaded images or other multimedia, giphys uploaded in the chat room, the tone of the conversation, the time between each word; and/or other insights derived from the content and interaction patterns of the room.

As illustrated in FIG. 6, the methods and systems of the present invention can detect, diagnose and predict the temperature and trajectory of the room. The temperature of the room represents the overall sentiment of the entire room for all parties involved. For instance, “hot” or “red” means there is a hot discussion going on among parties or “cold” or “blue” means overall the situation is under control and both parties are calm. Room temperature can calculated based on the certain features extracted from the room. This includes but not limited to the parties' sentiment; the parties' voice level and voice features; the parties' image features; meta data such as the time and the day that conversation happened; and/or demographics and psychographics of all parties. The room temperature can also be calculated based on a trajectory of the room temperature, which indicates the relative direction of the temperature with respect to current temperature (e.g., a “blue”/calm room warming up with current “hot” interaction raising the temperature). The room temperature can be calculated and visible with respect to the current temperature (e.g., mildly warm) and/or the trending temperature direction (e.g., warm but cooling).

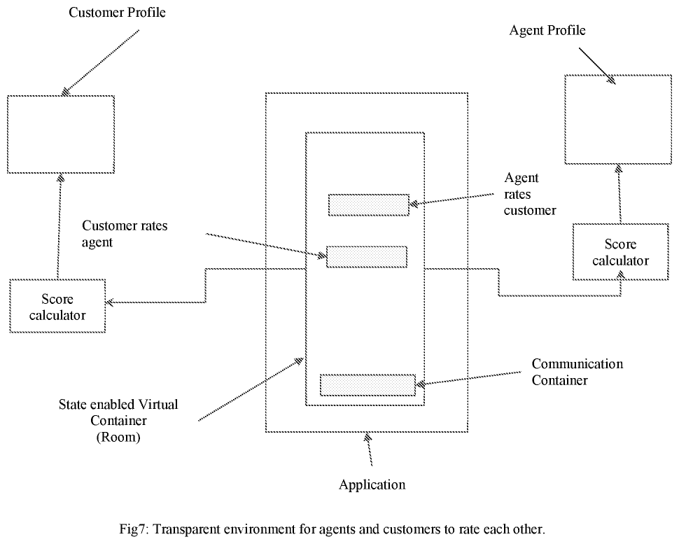

One of the major disadvantages of current customer service systems is the lack of visibility to the other party's performance. Such capability is already being practiced in ride-sharing services where the drivers and passengers can see other party ratings and after the service can rate them. Such capability creates a transparent ecosystem. To bring visibility to the platform of the present invention, the methods and systems of the present invention allow, in various embodiments, the parties to rate each other and leave comments for each other after an interaction/event in the room. For example, the customer can give four out of a possible four stars to the agent after the conversation, or the agent can give, for example, three out of four possible stars to the customer after the conversation and interaction, as illustrated in FIG. 7. In various embodiments, each party can make the rating open to public or not; each party can make the rating visible for management or not; each party might pay (to the owner, brand, etc.) to keep the rating private; the rating can be applied to any event occurring in the room; ratings can be aggregated and averaged to provide an overall rating; and/or ratings can be arbitrated to account for what would be considered “undeserved” or “malicious” ratings.

In addition to the rating system, a universal method can be used to calculate comprehensive scores for all parties (e.g., agents and customers). This is to make sure agents and customers can be compared in a universal scoring system. Such scoring can be used for customer satisfaction, employee evaluation, etc. These scores show the performance of a given person considering all factors including the following, as illustrated in FIG. 7: rating from customers or agents; capability to resolve issues; the average time of each interaction; the type of word chosen by each party; and/or all facial and body language signals.

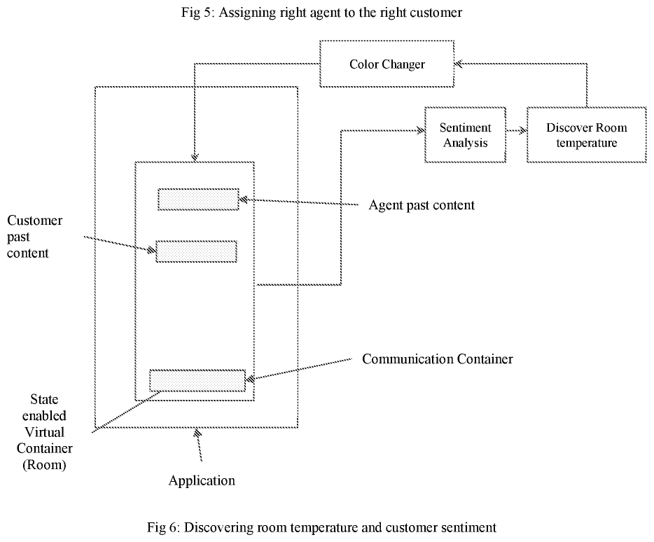

In current contact centers, it is not easy to talk to the agent that you are looking for. Hence, the need for ways to talk to your favorite agent or set of agents that fit in a certain criterion is inevitable. The methods and systems of the present invention can, in various embodiments, allow a customer to pick an agent via one of the following methods, as illustrated in FIG. 5. The customer could asks for any agent with behavior like the last agent they interacted with (e.g., calm, speaks slowly and clearly, etc.). A customer may ask for any agent who can solve a specific issue (e.g., refinancing my laptop). A customer may asks for the same agent as before. A customer may ask for a specific agent. A customer may ask for the best agent in each category (e.g., sales, support or commercial real-estate, etc.). A customer may ask for the best agent in a given time frame (e.g., best one in sales in past 3 month). A customer may ask for any combination of filters such as name, last name, skill set, etc. A customer may ask to pick agent based on their ratings. A customer may ask for an agent based on demographics (gender, age, etc.), location, etc. The selection criteria available to the customer for picking/filtering agents may be configurable (e.g., a business could restrict ability for customer to filter based on location, age, gender).

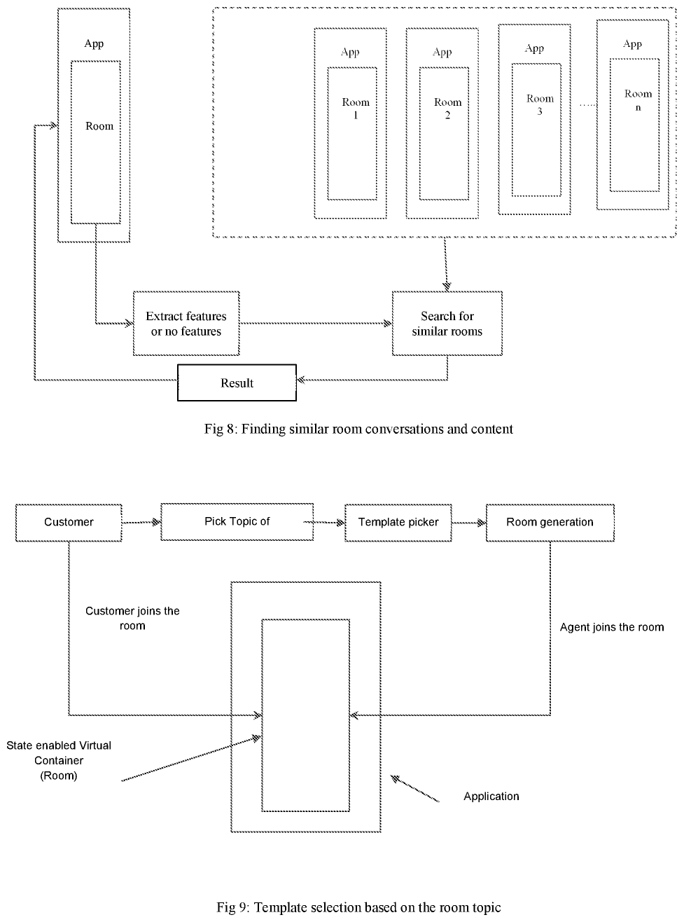

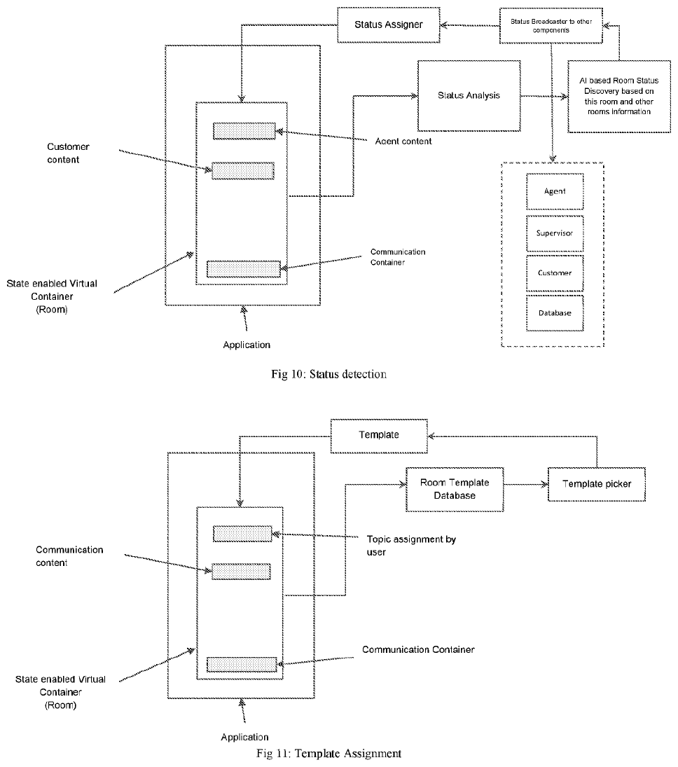

One of the major issues within a contact center is the presence of some useful information that no one can capture easily. For instance, an agent might have solved a tough issue for a customer ten minutes ago but there are ten more customers having the same issue at contact center and asking the same question. In this case those agents can answer the same question if they know another agent found the solution ten minutes ago. If a system can search and find similar rooms, then the agents' performance can be improved. To address this, the methods and systems of the present invention can search for a similar room to a given room. This method can search for a room with a similar context, as illustrated in FIG. 8. For instance, if the customer asked about how to refinance her laptop in another room, an agent might have provided a solution to the same question or similar questions.

A real-time, near real-time or batch mode module can analyze voice to extract voice features and/or transcribe voice to text. A real-time, near real-time or batch mode can analyze video and facial recognition module of conversations and extract the customer and agent facial state (e.g., angry, sad, happy, etc.) and/or a series of sequences that happen one after another such as a happy face after a sad face, etc. A natural language processing module that extracts valuable information from conversations. A feature-based system can find similar rooms based such features and attributes. The system can learn rules from the set of important features and apply such rule to next cases. A feature-less system can find a similar room based on raw data with no features including voice, video, and text signals. The system can use deep learning that does not extract any features, but rather learns from all raw data from a large set of datasets. Also, the system can learn to designate a room or recommend with a category.

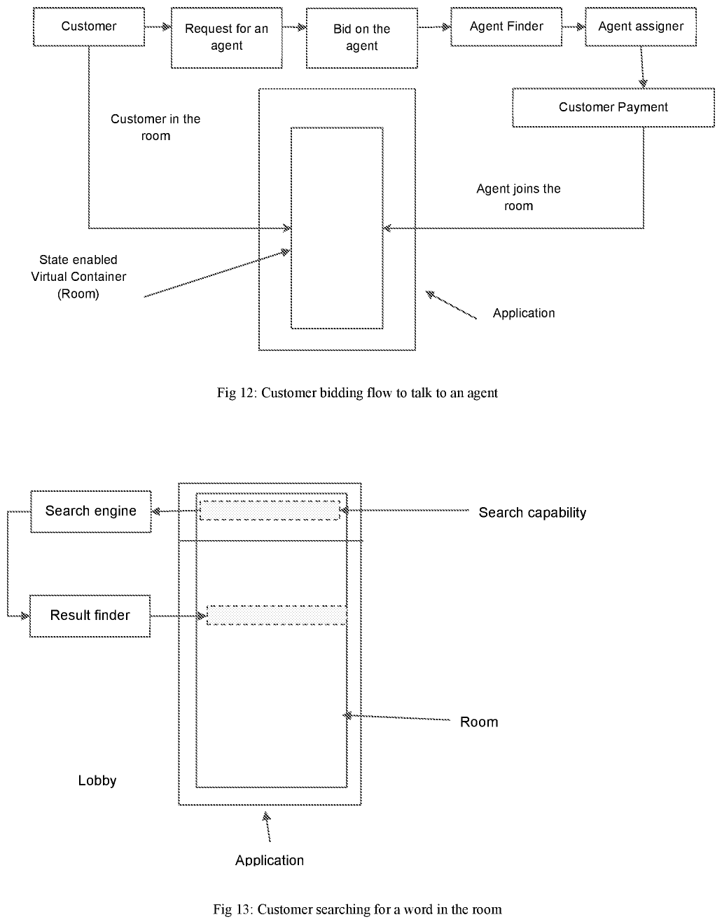

In current contact centers, generally there are two ways to treat customer, i.e., general (or non-VIP) customers and VIP customers. VIP customers are usually addressed right away whereas general customers typically have to wait in a first-in/first-out queue. In various embodiments, general customers can pay to get closer in the line. For instance, if a general customer is in rush and the general customer could pay to get his/her answer faster, indeed a bidding system can resolve this issue. With the same token one person (whether VIP or non-VIP) can sell their position to others and to those who are in rush to get their answer. To address this, the contact center can assign an agent to a given room based on the auction bid system as described in the FIG. 12. Customers can have the option to pay certain amount of virtual money, voucher, or money to push customer in front of the line—for instance customers can say “I will pay $10 to talk to an agent right now”. Customers can also have the option to receive certain amount of virtual money, voucher, or money to sell their position in the line to other. Customers can have the option to pay a certain amount of virtual money, voucher, or money with a certain time limit, e.g., customer can say “I will pay an extra $10 if I talk to an agent in 2 minutes”. Customers can have the option to pay and pick a certain time to be contacted or get notified, e.g., customers say “I will pay $10 extra and I need to be notified at 2:30 PM—as that is the only time I can talk”.

When users are in the room, they should be able to search. This capability could be searching for specific words (e.g., bicycle) or contextual search (e.g., bike) or the user can search internal database looking for other objects. Users can search one room, all their rooms, all other rooms that belong to other users and are public, etc. In this scenario if users are looking to find an answer for a specific question they can search for it, and find it, in other rooms as well. The methods and systems of the present invention can provide for contextual search within a room as illustrated in FIG. 13. The search can include web searches, such as the ability to execute general internet search while capturing context of the search. This can includes search terms, which are values entered by the user as keywords to be searched; visited results, e.g., if the user clicks into one of the searches results, then the URL will be noted; Tagged results, e.g., the user can tag a given web search result as being relevant; Rated Results, e.g., the option to provide a relevance rating of the specific web result, where the relevance rating for a given URL could be referenced and presented in the final search; and/or Aggregation, i.e., search results can be aggregated with other search types listed here. The search can also include internal database searches, e.g., the ability to search a content index specifically curated by the system. Internal database search results can be optimized based on an internal system rating and/or a customer relevance rating. Search results can be aggregated with other search types as listed here. Searches could also be made of external databases, which can provide the ability to search external systems for relevant content. Search results can stem from externally indexed data stores curated by third parties and/or can be aggregated with other type listed here. Also, searches could be made of other rooms, which provide the ability to search content within conversation in other rooms. The results of such a search could be a list of rooms meeting the search criteria. The results can be optimized and/or ranked based on room attributes, such as room temperature and/or the status of room (e.g., only closed rooms are searched).

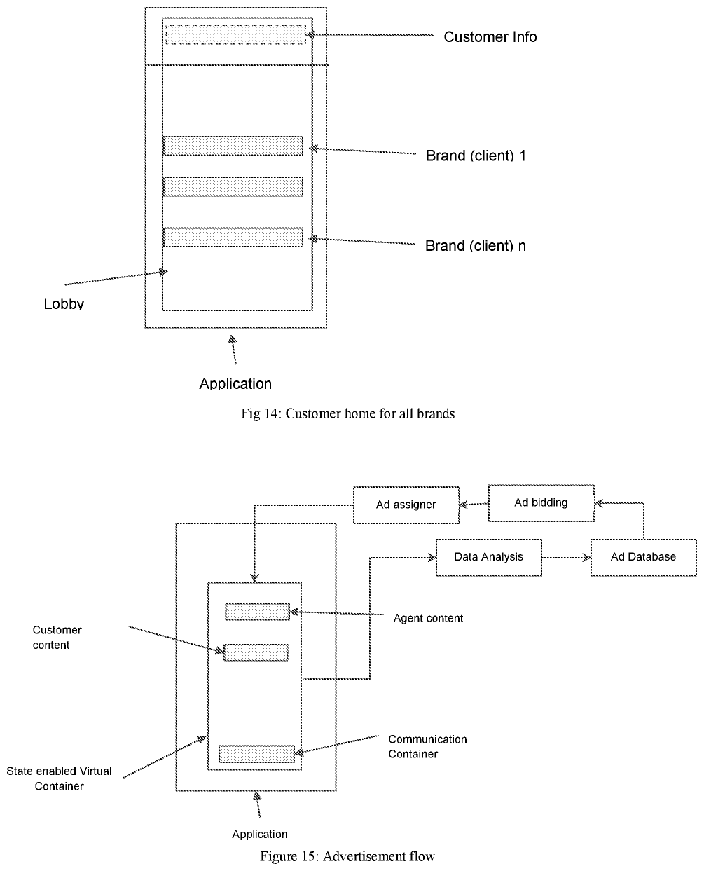

As described in FIG. 2, users might deal with more than one brand. They might use one brand for their home internet, another brand for shopping, another brand for utilities, another brand for electronics, etc. The ideal case for customers is to have all these brands in one place. Whether it is an app, web-app or a website, in various embodiments of the present invention users can easily navigate through all of their preferred brands and contact the right brand when they have an issue or they want to buy a product. Right now, there is not a universal app for customer engagement (e.g., sales, support, etc.). The methods and system of the present invention can provide for a double-sided all-in-one platform (e.g., an app, web app, software, cloud-based software, embedded software, etc.) for customers to deal with multiple brands (e.g., product, corporation, organization, person, and legal entity for customer service and for brands to provide service to their customers). As illustrated in FIG. 14, a customer can go to the list of all brands and pick the brand she likes for customer service and connect. The brands can connect with the customers via the same platform. A customer can see the sentiment of all customers on such brand. The brands can see the customer propensity toward their own brand. Also, the brands can see the customer propensity toward other brands.

As illustrated in FIG. 15, a room can be a rich environment with lots of information. This information could be in the form of text, audio, video, etc. Advertisers and brands can utilize such information to detect the interest of the users and to offer what might match with their interest. For instance, if customers are calling a contact center for their broken fridge, they might see an advertisement for a new brand fridge that fits within their budget. This is a unique opportunity for brands, competitors, and/or advertisers to connect with the right segment. The methods and systems of the present can provide for room based and service-based advertisement within the virtual container (e.g., room) environment. Advertisements could be in the form of audio, image, text, video, link, URL and any other digital asset (as shown in FIG. 15). Advertisements could be determined based on context of the room including but not limited to: text, emojis and conversation; uploaded images, audio, and video; and/or image and video of the conversation (e.g., if the person is happy, eating fruits etc.). Advertisements could be derived based on other data points, such as demographics, psychographics, and/or interactions within the platform.

One of the major issues in the current customer service and sales field is that either the communication is via email, which is outdated, or the customer and agent have to be present in the communication. The room concept provides an environment where the agent and customers can communicate and resolve issues totally asynchronous. A customer might ask something before leaving home to work; an agent might get back in an hour; the customer might answer back at noon time; and the agent might finally resolve the issue in the early afternoon. By the time that customer is home the problem is resolved. The methods and systems of the present invention can provide for asynchronous customer service and collaboration between agents and customers. The asynchronous nature of communication provides opportunities for both parties to communicate with each other on any time they want and provides opportunities for agents to resolve customer issues with customer pace. As illustrated in FIGS. 1 to 3, the asynchronous communication can be urgent and with latency (both options can be available). Also, an agent might get back later without calling the customer. The room data can be persistent and the customer can own the data including the text, audio, voice and video. The customer and agent can return to a room to see what activity has happened asynchronously and take appropriate action to progress the room forward toward conclusion. Also, customers can be notified if asynchronous activity occurs within the room allowing them to be aware and respond at their own time. The notification could be an in-app notification or a text message, for example.

Customer support ticket information can also be tracked for the rooms. When a customer raises a customer service issue, the corresponding agent can open a support ticket for the issue. The support ticket describes the interaction between a customer and a service representative. When the issue is resolved, the ticket is closed (and the room is closed), subject to later reopening. Each customer request gets its own unique ticket with a unique ticket number. This isolates customer requests so that nothing gets overlooked and makes it easy to search for and find specific interactions between the customers and agents. The support ticket can include updated information such as, for example, the urgency of the issue, where the error occurred (e.g., a URL), what the customer expected to happen, and what the agent (or brand) did to attempt to address the issue. The support ticket could include other information, particularly for different types of applications or contexts.

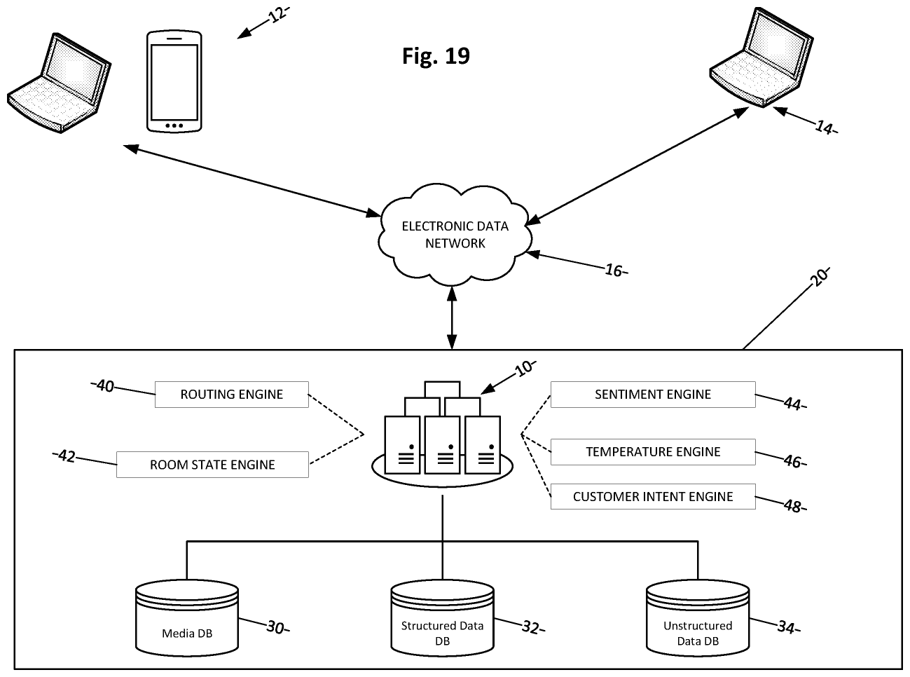

FIG. 19 illustrates a system according to various embodiments of the present invention. As shown in FIG. 19, the customer device 12 is a computer device with a processor and a memory, such as a smartphone, laptop, tablet computer, PC, etc. The customer device 12 includes software, that when executed by the customer device 12, displays the rooms for the customer associated with the customer device and allows the customer to interact with the agents via an electronic data network 16 (e.g., the Internet) and the customer service system 20. The software could be a mobile application, particularly where the customer device 12 is a mobile device such as a smartphone or tablet computer. The software could also be a browser or a plug-in that plugs into another application on the customer device 12. The software is stored in the memory of the customer device 12 and executed by the processor of the customer device 12.

Similarly, the agent device 14 is a computer device with a processor and a memory, such as a smartphone, laptop, tablet computer, PC, etc. The agent device 14 includes software, that when executed by the agent device 14, displays the rooms for the agent associated with the agent device and allows the agent to interact with the customers via the electronic data network 16 and the customer service system 20. The software could be a mobile application, particularly where the customer device 12 is a mobile device such as a smartphone or tablet computer. The software could also be a browser or a plug-in that plugs into another application on the agent device 14. The software is stored in the memory of the agent device 14 and executed by the processor of the agent device 14.

For illustrative purposes, FIG. 19 illustrates two instances of customer devices 12 and one instance of an agent device 14. In practice, there are likely to be many customer devices 12 communicating with agent devices 14 via the customer service system 20.

The customer service system 20 may be hosted on a cloud computing system. The customer service system 20 may be implemented as a virtual private cloud on the cloud computing system. That way, the customer service system 20 is isolated from other systems that are hosted by the cloud system resources. In that connection, internal components of the customer service system 20 may employ a private IP subnet and a virtual communication construct (such as a VLAN or a set of encrypted communication channels). As such, and as illustrated in FIG. 19, the customer service system 20 may be implemented with one or more cloud servers 10 and databases. The databases can include a media database 30 that stores media files for the customer service system 20, such as audio and video files for the communications between the customers and agents.

The customer service system 20 may also include a structured data database 32 that stores structured data for the customer service system 20. The stored structured data can comprise meta data about the rooms (when created, users, etc.), customer relationship management (CRM) data for the customers, data about the support tickets, data about the customers and agents, etc. The CRM data can comprise the names of the customers, contact information (e.g., email addresses) for the customers, demographic data for the customers (e.g., location, time zone, etc.) and “RFM” data. RFM data refers to data about the recency of the customers' communications with the service center, including about particular brands and issues; the frequency of the customers' communications with the service center; and the monetary value of the customers, such as the total amount a customer has spent purchasing products and services from a particular brand, or across multiple brands, over a particular period of time. The CRM data can also comprise data about the rooms, such as when the state of a room is changed and/or when a room is created and by whom.

The databases can also include an unstructured data database 34, which can store data about the messages (e.g., searchable text) between the customers and agents, as well as stream events (file sizes, times of events, etc.).

The servers 10 are configured, through programming, to perform various tasks ascribed to the customer service center herein. For example, the servers 10 can serve the data for the rooms to the customer and agent devices so that the customer and agent devices can display the rooms. To that end, the servers 10 may include web servers and/or application servers. The servers 10 can also implement, with a routing engine 40, the routing schemes to route customer calls to the selected agent(s). The servers 10 may also include engines 42, 44, 46, 48 that implement the trained, machine-learning models to determine, for example, the sentiments of the rooms (sentiment engine 44), the temperatures of the rooms (temperature engine 46), the states of the rooms (e.g., whether the state should be changed) (room state engine), and the customer intent (customer intent engine), as described herein. The engines 40, 42, 44, 46, 48 can be implemented as software to be executed by the processors of the servers 10.

The customer, agents and customer service center may communicate using protocols suitable for the communications, such as: hypertext transfer protocol (HTTP), an application layer protocol in the Internet protocol suite model for distributed, collaborative, hypermedia information systems; Short Message Service (SMS), a text messaging service component of most Internet and mobile device systems, which uses standardized communication protocols that let mobile devices exchange short text messages; Extensible Messaging and Presence Protocol (XMPP), an open communication protocol designed for instant messaging, presence information, and contact list maintenance, which is based on XML and which enables the near-real-time exchange of structured data between two or more network entities; and/or Voice over IP (VOIP), which is IP telephony for the delivery of voice communications and multimedia sessions over Internet Protocol networks.

The room state engine 42, sentiment engine 44, temperature engine 46 and customer intent engine 48 may be implemented, for example, a transformer, which is a deep learning model that adopts the mechanism of self-attention, differentially weighting the significance of each part of the input data. The transformers can process sequential input data, such as natural language, and can process the entire input all at once. The attention mechanism provides context for any position in the input sequence. For example, if the input data is a natural language sentence, the transformer does not have to process one word at a time. This allows for more parallelization and reduces training times. The inputs to the transformers, such as text, can be parsed into tokens by a byte pair encoding tokenizer, and each token can be converted via a word embedding into a vector. Then, positional information of the token can added to the word embedding.

The transformer models can also use an encoder-decoder architecture. The encoder can consist of encoding layers that process the input iteratively one layer after another, while the decoder consists of decoding layers that do the same thing to the encoder's output. The function of each encoder layer is to generate encodings that contain information about which parts of the inputs are relevant to each other. It passes its encodings to the next encoder layer as inputs. Each decoder layer does the opposite, taking all the encodings and using their incorporated contextual information to generate an output sequence. To achieve this, each encoder and decoder layer makes use of an attention mechanism. For each part of the input, attention weighs the relevance of every other part and draws from them to produce the output. Each decoder layer has an additional attention mechanism that draws information from the outputs of previous decoders, before the decoder layer draws information from the encodings. Both the encoder and decoder layers can have a feed-forward neural network for additional processing of the outputs and contain residual connections and layer normalization steps. Suitable types of transformer models can include a Universal Sentence Encoder (USE), a Generative Pretraining Transformer (GPT), and/or a Bidirectional Encoder Representations from Transformers (BERT).

The transformer models are pre-trained, such as through unsupervised, supervised, or semi-supervised learning to perform their various classification functions. The sentiment engine 44 can be trained to determine a score (such as, 0 to 100 or 0.0 to 1.00) reflecting the sentiment of a room. The sentiment score can be mapped to a sentiment classification, e.g., positive, negative, neutral, etc. The inputs for the sentiment transformer model, from which the sentiment classification is made, can include text (after NLP) of the communications between the customer and the agent, voice level and features of the participants, facial expressions of the participants, room meta data, and demographic and psychographic data of the participants. The sentiment training model can be trained from prior/historical room conversations to make the sentiment classifications.

The temperature engine 46 can be trained to determine a score (such as, 0 to 100 or 0.0 to 1.00) reflecting the temperature of a room. The temperature score can be mapped to a temperature classification, e.g., hot, cold, warm, chilly, etc. The inputs for the temperature transformer model, from which the temperature classification is made, can be similar to the inputs for the sentiment engine 44, and the temperature engine 46 can also use sentiments computed by the sentiment engine 44 to determine the temperature. The sentiment training model can be trained from prior/historical room conversations and computed sentiments from those conversation to make the temperature classifications.

The room state engine 42 can be trained to determine what state a room should be in and to change the state of the room when a change in the state is detected. The room state engine 42 can compute, on an ongoing basis while a room is active, a room state score (such as, 0 to 100 or 0.0 to 1.00) reflecting the room state. The room state score can be mapped to the appropriate room state, e.g., start negotiation, unfinished, and resolved. The inputs for the room state transformer model, from which the room state classification is made, can include the flow of conversation in the room and it can be trained from prior/historical room conversation flows to make the room state classifications.

The customer intent engine 48 can be trained to determine the intent of the customer. The customer intent engine 48 can compute, on an ongoing basis while a room is active, a customer intent score (such as, 0 to 100 or 0.0 to 1.00) reflecting the customer's intent. The customer intent score can be mapped to the appropriate customer intent classification. The inputs for the customer intent transformer model, from which the customer intent classification is made, can include, for example, the conversation of the participants of the room and CRM data for the customer, including the RFM data. It can also include room meta data. The customer intent model can be trained from prior/historical room conversation flows, and the CRM data for the customers in this historical conversations, to make the customer intent classifications.

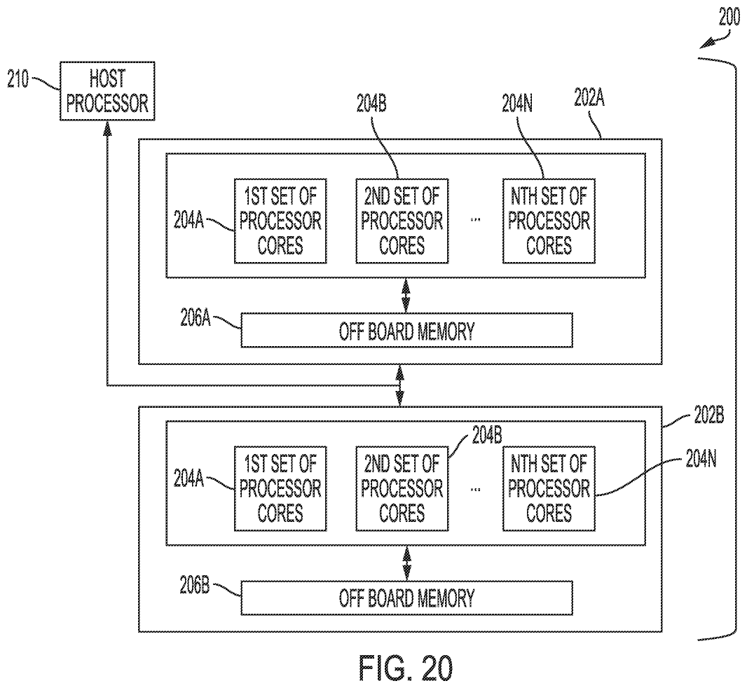

FIG. 20 is a diagram of a computer system 200 that could be used to train any or all of the machine learning models 42, 44, 46, 48. The illustrated computer system 200 comprises multiple processor units 202A-B that each comprises, in the illustrated embodiment, multiple (N) sets of processor cores 204A-N. Each processor unit 202A-B may comprise on-board memory (ROM or RAM) (not shown) and off-board memory 206A-B.

The on-board memory may comprise primary, volatile and/or non-volatile, storage (e.g., storage directly accessible by the processor cores 204A-N). The off-board memory 206A-B may comprise secondary, non-volatile storage (e.g., storage that is not directly accessible by the processor cores 204A-N), such as ROM, HDDs, SSD, flash, etc. The processor cores 204A-N may be CPU cores, GPU cores and/or AI accelerator cores. GPU cores operate in parallel (e.g., a general-purpose GPU (GPGPU) pipeline) and, hence, can typically process data more efficiently that a collection of CPU cores, but all the cores of a GPU execute the same code at one time. AI accelerators are a class of microprocessor designed to accelerate artificial neural networks. They typically are employed as a co-processor in a device with a host CPU 210 as well. An AI accelerator typically has tens of thousands of matrix multiplier units that operate at lower precision than a CPU core, such as 8-bit precision in an AI accelerator versus 64-bit precision in a CPU core.

In various embodiments, the different processor cores 204 may train and/or implement different models 42, 44, 46, 48. For example, in one embodiment, the cores of the first processor unit 202A may implement the model 42 and the second processor unit 202B may implement the model 44 and so on. One or more host processors 210 may coordinate and control the processor units 202A-B.

The models 42, 44, 46, 48 can be embodied as a set of instructions stored within a memory (e.g., an integral memory of the processing units 202A, 202B or an off board memory 206A couple to the processing units 202A, 202B or other processing units) coupled to one or more processors (e.g., at least one of the sets of processor cores 204A-N of the processing units 202A, 202B or another processor(s) communicatively coupled to the processing units 202A, 202B), such that, when executed by the one or more processors, the instructions cause the processors to perform the aforementioned process of the various models by, for example, controlling the machine learning modules stored in the processing units 202A, 202B.

The software for the various computer systems described herein and other computer functions described herein may be implemented in computer software using any suitable computer programming language such as .NET, C, C++, Python, and using conventional, functional, or object-oriented techniques. Programming languages for computer software and other computer-implemented instructions may be translated into machine language by a compiler or an assembler before execution and/or may be translated directly at run time by an interpreter. Examples of assembly languages include ARM, MIPS, and x86; examples of high level languages include Ada, BASIC, C, C++, C#, COBOL, Fortran, Java, Lisp, Pascal, Object Pascal, Haskell, ML; and examples of scripting languages include Bourne script, JavaScript, Python, Ruby, Lua, PHP, and Perl.

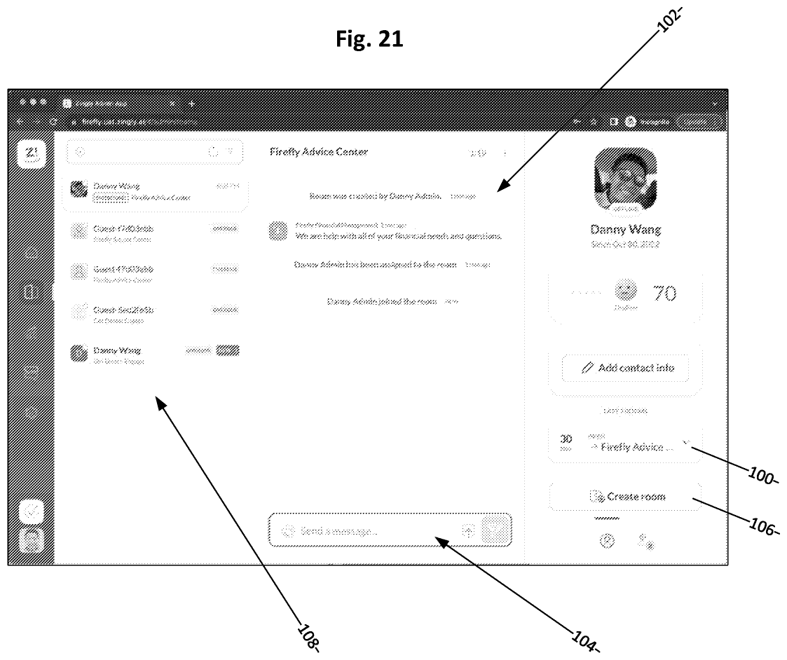

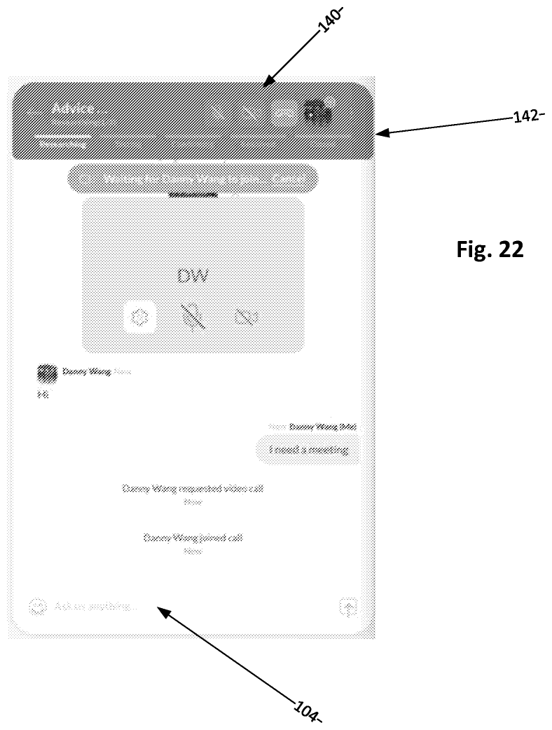

FIG. 21 depicts an example screen shot that an agent be shown by the app running on the agent device 14. Field 100 lists recent rooms of the agent. In this example, the agent has one currently open room, “Firefly Advice Center.” Field 102 shows the room where the customer and agent can conduct their conversation. The room 102 can open when the agent clicks or otherwise activates the icon 100 for the room. The agent can enter text for the conversation in text field 104. The user can also upload audio or video files to the room via the text field 104. The customer and agent may also conduct a video call in the room as described herein. The agent can also commence opening a new room by clicking (or otherwise activating) the “create room” both 106. Field 108 can show other rooms for the agent to join.

FIG. 22 show an example room from the perspective of a customer according to various embodiments. As shown in the example room, the room can capture the messages between the participants. There are also controls 140 for the customer to invoke other types of communications with the agent, such as a video or audio call. The customer room also has the text field 104 to enter a text, video or audio message. Also, the room may show the status of the ticket/room in a banner 142 as described herein.

A customer's customer service issue can be, for example, sales related (e.g., issues related to a purchase) or technical in nature. Technical issues can relate to getting a product, such as a computer, appliance, tool, or software, to work properly. The customer service system of the present invention, as described herein, can allow the agent to more efficiently and expeditiously address a customer's technical issue so that the customer's computer, appliance, tool, software, etc., as the case may be, returns to an operative state or otherwise operates as it is supposed to. The appliance could be a kitchen appliance. The tool could be power tool, etc.

A system according to embodiments of the present invention can comprise: a customer service center 20 that comprises one or more servers 10 and a plurality of databases; a customer device 10 associated with a customer; and a first agent device 14 associated with a first agent. The customer service device is in communication with the customer server center via an electronic data network 16. The first agent device is in communication with the customer service center via the electronic data network.

The customer service center comprises a routing engine 40 for selecting the first agent, from a plurality of customer service agents, to address a customer service issue of the customer. The routing engine is for selecting the first agent in response to an incoming communication, via the electronic data network, from the customer device.

The customer service center is configured to serve data both the customer device and the first agent device, for the customer device and the first agent device to each display visually, a customer service container for the customer device and the agent device to communicate with the agent to address the customer service issue of the customer. The customer service container comprises, and displays visually for the customer and first agent: communications between the customer device and the first agent device in multiple possible communication media formats, (e.g., text, audio and video); support ticket information for the customer service issue of the customer, where a support ticket is opened by the customer service center when the customer raises a new customer service issue and the support ticket is when the customer service issue of the customer is resolved; and customer relationship management (CRM) data for the customer. The customer service center is configured to close the customer service container when the support ticket for the customer service issue of the customer is closed.

The customer service center stores in a media database 30 of the customer service center, media files for media used in the communications between the customer and first agent; in a structured data database 32 of the customer service center, container meta data for the customer support container and CRM data for the customer; and in an unstructured data database 34 of the customer service center, message data from messages between the customer and first agent, wherein the message data comprises searchable text.

The customer service center can further comprise a sentiment engine 44 to classify, on an ongoing basis during communications between the customer and the first agent, a present sentiment of the communications between the customer and the first agent to address the customer service issue of the customer. The sentiment engine can comprise a first deep learning transformer model, that is pre-trained, to classify the present sentiment based on first input data to the first deep learning transformer model. The first input data can comprise text from the communications between the customer and the first agent, the support ticket information, the CRM data, and data about the first agent. The customer service container can indicate visually the present sentiment of the communications between the customer and the first agent.

The customer service center can further comprise a temperature engine to classify, on an ongoing basis during the communications between the customer and the first agent, a present temperature of the communications between the customer and the first agent to address the customer service issue of the customer. The temperature engine can comprise a second deep learning transformer model, that is pre-trained, to classify the present temperature based on second input data to the second deep learning transformer model. The second input data can comprise, among other things, the present sentiment. Also, the customer service container can indicate visually the present temperature of the communications between the customer and the first agent.

The CRM data stored by structured data database comprise can container data for the customer. The container data can comprise a time when the customer service container was created and state data for the customer service container, where the state data can comprise current and past states for the customer service container. In that connection, the customer service center can further comprise a room state engine to classify, on an ongoing basis during the communications between the customer and the first agent, a present room state for the customer service container. The room state engine can comprise a third deep learning transformer model, that is pre-trained, to classify the present room state of the customer service container based on third input data to the third deep learning transformer model. The third input data can comprise, among other things, text from the communications between the customer and the first agent.

The customer service center can further comprise a customer intent engine to classify, on an ongoing basis during the communications between the customer and the first agent, a present customer intent for the customer. The customer intent engine can comprise a fourth deep learning transformer model, that is pre-trained, to classify the present customer intent of the customer based on fourth input data to the fourth deep learning transformer model. The fourth input data can comprise, among other things, CRM data for the customer.

The customer service container can comprise an option for both the customer and the first agent to close the support ticket. The customer service center can close the customer service container in response to the support ticket being closed. The customer service center can be configured to: re-open a previously closed support ticket in response from a communication from the customer device to re-open the previously closed support ticket; and reopen a customer service container for the previously closed support ticket in response to re-opening the previously closed support ticket.

The customer service center is hosted on a virtual private cloud of a cloud computing system.

In one general aspect, the present invention is directed to a method that comprises the step of selecting, by a routing engine of a customer service center, a first agent, from a plurality of customer service agents, to address a customer service issue of a customer. The routing engine is for selecting the first agent in response to an incoming communication, via an electronic data network, from a customer device associated with the customer, and the first agent is associated with a first agent device. The method also comprises the step of serving, by the customer service center, data to both the customer device and the first agent device, for the customer device and the first agent device to each display visually, a customer service container for the customer device and the agent device to communicate with the agent to address the customer service issue of the customer. The customer service container comprises, and displays visually for the customer and first agent: communications between the customer device and the first agent device in multiple possible communication media formats (where the multiple possible communication media formats comprise text, audio and video); support ticket information for the customer service issue of the customer, wherein a support ticket is opened by the customer service center when the customer raises a new customer service issue and the support ticket is when the customer service issue of the customer is resolved; and customer relationship management (CRM) data for the customer. The method also comprises the step of closing, by the customer service center, the customer service container when the support ticket for the customer service issue of the customer is closed. The method also comprises the step of storing, by the customer service center: in a media database of the customer service center, media files for media used in the communications between the customer and first agent; in a structured data database of the customer service center, container meta data for the customer service container and CRM data for the customer; and in an unstructured data database of the customer service center, message data from messages between the customer and first agent, where the message data comprises searchable text.

In various embodiments, the method also comprises training, by a computer system, a sentiment engine to classify a present sentiment of communications in a customer service container. The sentiment engine comprises a first deep learning transformer model, and the training comprises training the sentiment engine to classify the present sentiment based on first input data to the first deep learning transformer model. The first input data comprises, among other possible data, text from the communications from the customer service container, the support ticket information, the CRM data, and agent data. The method also comprises, after training the sentiment engine, classifying, by the sentiment engine, the present sentiment of communications in the customer service container between the customer and the first agent, on an ongoing basis during the communications between the customer and the first agent, such that the customer service container indicates visually the present sentiment of the communications between the customer and the first agent.

The method may also comprise the step of training, by the computer system, a temperature engine to classify a present temperature of communications in a customer service container. The temperature engine comprises a second deep learning transformer model, and the training comprises training the temperature engine to classify the present temperature based on second input data to the second deep learning transformer model. The second input data comprises, among other possible data, the present sentiment for the customer service container. The method can also comprise the step of, after training the temperature engine, classifying, by the temperature engine, the present temperature of the communications in the customer service container between the customer and the first agent, on an ongoing basis during the communications between the customer and the first agent, where the customer service container indicates visually the present temperature of the communications between the customer and the first agent.

The CRM data stored by structured data database may comprise container data for the customer, where the container data comprise a time when the customer service container was created and state data for the customer service container, and where the state data comprises current and past states for the customer service container. The method may also comprise the step of training, by the computer system, a room state engine to classify a present room state of communications in a customer service container. The room state engine comprises a third deep learning transformer model, and the training comprises training the room state engine to classify the present sentiment based on third input data to the third deep learning transformer model. The third input data comprises, among other possible data, text from the communications in the customer service container. The method also comprises the step of, after training the room state engine, classifying, by the room state engine, the present room state of the customer service container for the customer and the first agent, on an ongoing basis during the communications between the customer and the first agent.

The method may also comprise training, by the computer system, a customer intent engine to classify a present customer intent of customers. The customer intent engine comprises a fourth deep learning transformer model, and the training comprises training the customer intent engine to classify the present customer intent based on fourth input data to the fourth deep learning transformer model. The fourth input data comprises, among other possible data, CRM data for the customers. The method can also comprise, after training the room state engine, classifying, by the customer intent engine, the present customer intent of the customer and the first agent, on an ongoing basis during the communications between the customer and the first agent.

In various implementation, the customer service container can comprises an option for both the customer and the first agent to close the support ticket, where the customer service center closes the customer service container in response to the support ticket being closed. In that connection, the method can further comprise the step of: re-opening, by the customer service center, a previously closed support ticket in response from a communication from the customer device to re-open the previously closed support ticket; and reopening, by the customer service center, a customer service container for the previously closed support ticket in response to re-opening the previously closed support ticket.

The software for the servers 10, customer device 12 and agent device 14 described herein and other computer functions described herein may be implemented in computer software using any suitable computer programming language, such as .NET, C, C++, or Python, and using conventional, functional, or object-oriented techniques. For example, the various machine learning systems may be implemented with software modules stored or otherwise maintained in computer readable media, e.g., RAM, ROM, secondary storage, etc. One or more processing cores (e.g., CPU) of the various devices may then execute the software modules to implement the function of the computer system.

Programming languages for computer software and other computer-implemented instructions may be translated into machine language by a compiler or an assembler before execution and/or may be translated directly at run time by an interpreter. Examples of assembly languages include ARM, MIPS, and x86; examples of high-level languages include Ada, BASIC, C, C++, C#, COBOL, Coq, Fortran, Java, Lisp, Pascal, Object Pascal, Haskell, ML; and examples of scripting languages include Bourne script, JavaScript, Python, Ruby, Lua, PHP, and Perl.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. Further, it is to be understood that the figures and descriptions of the present invention have been simplified to illustrate elements that are relevant for a clear understanding of the present invention, while eliminating, for purposes of clarity, other elements. While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

In summary, numerous benefits have been described which result from employing the inventions described herein. The foregoing description of the embodiments has been presented for purposes of illustration and description. It is not intended to be exhaustive or limiting to the precise form disclosed. Modifications or variations are possible in light of the above teachings. The one or more embodiments were chosen and described in order to illustrate principles and practical application to thereby enable one of ordinary skill in the art to utilize the various embodiments and with various modifications as are suited to the particular use contemplated. It is intended that the claims submitted herewith define the overall scope.

1. A system comprising:
a customer service center that comprises one or more servers and a plurality of databases;
a customer device associated with a customer, wherein the customer device is in communication with the customer service center via an electronic data network; and
a first agent device associated with a first agent, wherein the first agent device is in communication with the customer service center via the electronic data network,
wherein:
the customer service center comprises a routing engine for selecting the first agent, from a plurality of customer service agents, to address a customer service issue of the customer, wherein the routing engine is for selecting the first agent in response to an incoming communication, via the electronic data network, from the customer device;
the customer service center is configured to serve data to both the customer device and the first agent device, for the customer device and the first agent device to each display visually, a customer service container for the customer device and the first agent device to communicate with the first agent to address the customer service issue of the customer;
the customer service container comprises, and displays visually for the customer and the first agent:
communications between the customer device and the first agent device in multiple possible communication media formats, wherein the multiple possible communication media formats comprise text, audio and video;
support ticket information for the customer service issue of the customer, wherein a support ticket is opened by the customer service center when the customer raises a new customer service issue and the support ticket is closed when the customer service issue of the customer is resolved; and
customer relationship management (CRM) data for the customer;
the customer service center is configured to close the customer service container when the support ticket for the customer service issue of the customer is closed;
the customer service center stores:
in a media database of the customer service center, media files for media used in the communications between the customer device and the first agent device;
in a structured data database of the customer service center, container meta data for the customer service container and CRM data for the customer; and
in an unstructured data database of the customer service center, message data from messages between the customer and the first agent, wherein the message data comprises searchable text.

2. The system of claim 1, wherein:
the customer service center further comprises a sentiment engine to classify, on an ongoing basis during communications between the customer and the first agent, a present sentiment of the communications between the customer and the first agent to address the customer service issue of the customer, wherein the sentiment engine comprises a first deep learning transformer model, that is pre-trained, to classify the present sentiment based on first input data to the first deep learning transformer model, wherein the first input data comprises text from the communications between the customer and the first agent, the support ticket information, the CRM data, and data about the first agent; and
the customer service container indicates visually the present sentiment of the communications between the customer and the first agent.

3. The system of claim 2, wherein:
the customer service center further comprises a temperature engine to classify, on an ongoing basis during the communications between the customer and the first agent, a present temperature of the communications between the customer and the first agent to address the customer service issue of the customer, wherein the temperature engine comprises a second deep learning transformer model, that is pre-trained, to classify the present temperature based on second input data to the second deep learning transformer model, wherein the second input data comprises the present sentiment; and
the customer service container indicates visually the present temperature of the communications between the customer and the first agent.

4. The system of claim 3, wherein the CRM data stored by the structured data database comprise container data for the customer, wherein the container data comprise a time when the customer service container was created and state data for the customer service container, wherein the state data comprise current and past states for the customer service container.

5. The system of claim 4, wherein the customer service center further comprises a room state engine to classify, on an ongoing basis during the communications between the customer and the first agent, a present room state for the customer service container, wherein the room state engine comprises a third deep learning transformer model, that is pre-trained, to classify the present room state of the customer service container based on third input data to the third deep learning transformer model, wherein the third input data comprise text from the communications between the customer and the first agent.

6. The system of claim 5, wherein the customer service center further comprises a customer intent engine to classify, on an ongoing basis during the communications between the customer and the first agent, a present customer intent for the customer, wherein the customer intent engine comprises a fourth deep learning transformer model, that is pre-trained, to classify the present customer intent of the customer based on fourth input data to the fourth deep learning transformer model, wherein the fourth input data comprise CRM data for the customer.

7. The system of claim 1, wherein the customer service container comprises an option for both the customer and the first agent to close the support ticket, wherein the customer service center closes the customer service container in response to the support ticket being closed.

8. The system of claim 7, wherein the customer service center is configured to:
re-open a previously closed support ticket in response to a communication from the customer device to re-open the previously closed support ticket; and
re-open a customer service container for the previously closed support ticket in response to re-opening the previously closed support ticket.

9. The system of claim 1, wherein the customer service center is hosted on a virtual private cloud of a cloud computing system.

10. A method comprising:
selecting by a routing engine of a customer service center, a first agent, from a plurality of customer service agents, to address a customer service issue of a customer, wherein the routing engine is for selecting the first agent in response to an incoming communication, via an electronic data network, from a customer device associated with the customer, and wherein the first agent is associated with a first agent device;
serving, by the customer service center, data to both the customer device and the first agent device, for the customer device and the first agent device to each display visually, a customer service container for the customer device and the first agent device to communicate with the first agent to address the customer service issue of the customer;
wherein the customer service container comprises, and displays visually for the customer and the first agent:
communications between the customer device and the first agent device in multiple possible communication media formats, wherein the multiple possible communication media formats comprise text, audio and video;
support ticket information for the customer service issue of the customer, wherein a support ticket is opened by the customer service center when the customer raises a new customer service issue and the support ticket is closed when the customer service issue of the customer is resolved; and
customer relationship management (CRM) data for the customer;
closing, by the customer service center, the customer service container when the support ticket for the customer service issue of the customer is closed; and
storing, by the customer service center:
in a media database of the customer service center, media files for media used in the communications between the customer and the first agent;
in a structured data database of the customer service center, container meta data for the customer service container and CRM data for the customer; and
in an unstructured data database of the customer service center, message data from messages between the customer and the first agent, wherein the message data comprise searchable text.

11. The method of claim 10, further comprising:
training, by a computer system, a sentiment engine to classify a present sentiment of communications in a customer service container, wherein the sentiment engine comprises a first deep learning transformer model, and the training comprises training the sentiment engine to classify the present sentiment based on first input data to the first deep learning transformer model, wherein the first input data comprise text from the communications from the customer service container, the support ticket information, the CRM data, and first agent data; and
after training the sentiment engine, classifying, by the sentiment engine, the present sentiment of communications in the customer service container between the customer and the first agent, on an ongoing basis during the communications between the customer and the first agent, wherein the customer service container indicates visually the present sentiment of the communications between the customer and the first agent.

12. The method of claim 11, further comprising:
training, by the computer system, a temperature engine to classify a present temperature of communications in a customer service container, wherein the temperature engine comprises a second deep learning transformer model, and the training comprises training the temperature engine to classify the present temperature based on second input data to the second deep learning transformer model, wherein the second input data comprise the present sentiment for the customer service container; and
after training the temperature engine, classifying, by the temperature engine, the present temperature of the communications in the customer service container between the customer and the first agent, on an ongoing basis during the communications between the customer and the first agent, wherein the customer service container indicates visually the present temperature of the communications between the customer and the first agent.

13. The method of claim 12, wherein the CRM data stored by the structured data database comprise container data for the customer, wherein the container data comprise a time when the customer service container was created and state data for the customer service container, wherein the state data comprise current and past states for the customer service container.

14. The method of claim 13, further comprising:
training by the computer system, a room state engine to classify a present room state of communications in a customer service container, wherein the room state engine comprises a third deep learning transformer mode, and the training comprises training the room state engine to classify the present sentiment based on third input data to the third deep learning transformer model, wherein the third input data comprise text from the communications in the customer service container; and
after training the room state engine, classifying, by the room state engine, the present room state of the customer service container for the customer and the first agent on an ongoing basis during the communications between the customer and the first agent.

15. The method of claim 14, further comprising:
training, by the computer system, a customer intent engine to classify a present customer intent of customers, wherein the customer intent engine comprises a fourth deep learning transformer model, and the training comprises training the customer intent engine to classify the present customer intent based on fourth input data to the fourth deep learning transformer model, wherein the fourth input data comprise CRM data for the customers; and
after training the room state engine, classifying, by the customer intent engine, the present customer intent of the customers and the first agent, on an ongoing basis during the communications between the customer and the first agent.

16. The method of claim 10, wherein the customer service container comprises an option for both the customer and the first agent to close the support ticket, wherein the customer service center closes the customer service container in response to the support ticket being closed.

17. The method of claim 16, further comprising:
re-opening, by the customer service center, a previously closed support ticket in response to a communication from the customer device to re-open the previously closed support ticket; and
re-opening, by the customer service center, a customer service container for the previously closed support ticket in response to re-opening the previously closed support ticket.
